(19) United States
(12) Patent Application Publication
(10) Pub. No.: US 2010/0010175 A1
(43) Pub. Date: Jan. 14, 2010

(54) Additives for Polyolefin Extruder Start-Up

(75) Inventors: Tim Coffy, Houston, TX (US); Marc Mayhall, Houston, TX (US); Mark Leland, Houston, TX (US); Jeff Tilley, Houston, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 12/169,079

(22) Filed: Jul. 8, 2008

(51) Int. Cl. C08F 2/00; C08F 110/06

(52) U.S. Cl. 526/86; 526/351

(57) ABSTRACT

Polymerization processes and polymers formed therefrom are described herein. The polymerization processes generally include contacting an olefin monomer with a catalyst system to form polymer within a reaction vessel, withdrawing polymer from the reaction vessel, contacting the polymer with one or more initiation additives to form a modified polymer and extruding the modified polymer.

### FIELD

Embodiments of the present invention generally relate to olefin polymerization processes.

### BACKGROUND

Polymerization processes generally include extrusion of molten polymer passed from reaction vessels. Initiating the extrusion of many polymers, such as high melt flow and/or low viscosity polymers, has been difficult due to the tendency of the polymers to stick to extruder parts.

Therefore, a need exists to develop processes for initiating the extrusion of such polymers.

### SUMMARY

Embodiments of the present invention include polymerization processes. The polymerization processes generally include contacting an olefin monomer with a catalyst system to form polymer within a reaction vessel, withdrawing polymer from the reaction vessel, contacting the polymer with one or more initiation additives to form a modified polymer and extruding the modified polymer.

One or more embodiments include contacting propylene monomer with a metallocene catalyst system to form unmodified polypropylene within a reaction vessel, wherein the polypropylene exhibits a melt flow rate of at least 20 g/10 min.

One or more embodiments include contacting the unmodified polypropylene with a first initiation additive including talc and a second initiation additive including a migratory slip agent to form a modified polymer.

One or more embodiments include terminating the contact of the unmodified polypropylene with the one or more initiation additives to form modified polymer and extruding the unmodified polypropylene without interruption to form polymer pellets.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents at the time of filing. Further, unless otherwise specified, all compounds described herein may be substituted or unsubstituted and the listing of compounds includes derivatives thereof.

Various ranges are further recited below. It should be recognized that unless stated otherwise, it is intended that the endpoints are to be interchangeable. Further, any point within that range is contemplated as being disclosed herein.

Polymerization processes are described herein.

### Catalyst Systems

Catalyst systems useful for polymerizing olefin monomers include any catalyst system known to one skilled in the art. For example, the catalyst system may include metallocene catalyst systems, single site catalyst systems, Ziegler-Natta catalyst systems or combinations thereof, for example. As is known in the art, the catalysts may be activated for subsequent polymerization and may or may not be associated with a support material. A brief discussion of such catalyst systems is included below, but is in no way intended to limit the scope of the invention to such catalysts.

For example, Ziegler-Natta catalyst systems are generally formed from the combination of a metal component (e.g., a catalyst) with one or more additional components, such as a catalyst support, a cocatalyst and/or one or more electron donors, for example.

Metallocene catalysts may be characterized generally as coordination compounds incorporating one or more cyclopentadienyl (Cp) groups (which may be substituted or unsubstituted, each substitution being the same or different) coordinated with a transition metal through π bonding. The substituent groups on Cp may be linear, branched or cyclic hydrocarbyl radicals, for example. The cyclic hydrocarbyl radicals may further form other contiguous ring structures, including indenyl, azulenyl and fluorenyl groups, for example. These contiguous ring structures may also be substituted or unsubstituted by hydrocarbyl radicals, such as C₁ to C₂₀ hydrocarbyl radicals, for example.

### Polymerization Processes

As indicated elsewhere herein, catalyst systems are used to form polyolefin compositions. Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,1.47,173, which are incorporated by reference herein.)

In certain embodiments, the processes described above generally include polymerizing one or more olefin monomers to form polymers. The olefin monomers may include C₂ to C₃₀ olefin monomers, or C₂ to C₁₂ olefin monomers (e.g., ethylene, propylene, butene, pentene, methylpentene, hexene, octene and decene), for example. The monomers may include olefinic unsaturated monomers, C₄ to C₁₈ diolefins, conjugated or nonconjugated dienes, polyenes, vinyl monomers and cyclic olefins, for example. Non-limiting examples of other monomers may include norbornene, nobornadiene, isobutylene, isoprene, vinylbenzocyclobutane, sytrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process with the exception that the liquid medium is also the reactant (e.g., monomer) in a bulk phase process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any method known to one skilled in the art, such as via a doublejacketed pipe or heat exchanger, for example.

Alternatively, other types of polymerization processes may be used, such as stirred reactors in series, parallel or combinations thereof, for example.

Upon removal from the reactor, the polymer is generally passed to a polymer recovery system for further processing. In one or more embodiments, the polymer recovery system includes extrusion. Extrusion processes are well known and generally include extruding molten polymer particles (e.g., passing molten polymer through a die), cooling the polymer and cutting the polymer to form pellets.

Historically, initiating extrusion of high melt flow rate (MFR) polymers (discussed in further detail below) has been difficult, if not impossible, at least in part due to their tendency to stick to machine parts within the extruder. As a result, the high melt flow rate polymers generally experience a narrow extruder processing window, resulting in difficult extruder operation in a commercial environment. As used herein, “commercial production” refers to polymer production of at least 1 ton/hour. For example, commercial production may include polymer production of from about 1 ton/hour to about 5 tons/hour, or from about 1 ton/hour to about 50 tons/hour. For example, the processing window generally requires little to no polymer residence time in the extruder prior to start-up, a very clean extruder die prior to extrusion initiation and/or a significant purge time within the extruder prior to extrusion. As used herein, “purge” refers to passing polymer through the extruder for a period of time prior to commercial production. If the extrusion process is operated outside of the narrow processing window, the high melt flow rate polymers tend to stick to extruder equipment, commonly requiring extruder shut-down. Extruder shut-down can further result in costly polymer reaction vessel shut-downs.

However, embodiments of the invention unexpectedly result in the ability to initiate extrusion of high melt flow rate polymers outside of the narrow process window described above.

Embodiments of the invention generally include blending one or more initiation additives with the high melt flow rate polymers prior to extrusion to form modified polymers. The one or more initiation additives are generally selected from first initiation additives, second initiation additives and combinations thereof.

The first initiation additives may be selected from talc, silica, zinc oxide, sodium benzoate carboxylic acid salts, including sodium benzoate, phosphates, metallic-silicate hydrates, organic derivatives of dibenzylidene sorbitol, sorbitol acetals, organophosphate salts, Amfine Na-11, Na-21 and Na-71, commercially available from Amfine Chemical, Milliken HPN-68, HPN-68L, HPN-600 and Millad 3988, commercially available from Milliken Chemical, and combinations thereof, for example. In one embodiment, the first initiation additive includes talc.

One or more embodiments include blending from about 0.05 wt. % to about 5 wt. %, or from about 0.8 wt. % to about 4.0 wt. % or from about 1.0 wt. % to about 3.5 wt. % first initiation additive (based on the total weight of polymer) with the high melt flow rate polypropylene, for example.

The second initiation additive generally includes migratory slip agents as known to one skilled in the art (e.g., an additive providing surface lubrication during and immediately following polymer processing). For example, the migratory slip agents may be selected from stearates, stearamides, including ethylene bis-stearamide (EBS), oleamides, behenamides, erucamides and combinations thereof; for example. In one embodiment, the migratory slip agent includes EBS. As used herein, the term “migratory slip agent” refers to an additive that provides surface lubrication during and immediately following processing, such as extrusion.

One or more embodiments include blending from about 0.05 wt. % to about 5.0 wt. %, or from about 0.1 wt. % to about 3 wt. % or from about 0.1 wt. % to about 1.0 wt. % second initiation additive with the high melt flow rate polypropylene, for example.

In one or more embodiments, the initiation additives include at least one first initiation additive and at least one second initiation additive. When a plurality of initiation additives are utilized (e.g., the first initiation additive and the second initiation additive), the total amount of initiation additive may be from 0.05 wt. % to about 5 wt. %, or from about 0.05 wt. % to about 4 wt. % or from about 0.10 wt. % to about 3 wt. % based on the amount of high MFR polymer, for example. In one or more embodiments, the first initiation additive is added in an amount greater than the amount of second initiation additive.

The initiation additives may be blended with the high melt flow rate polymer in any manner known to one skilled in the art. For example, the initiation additives may individually be blended with the high melt flow rate polymer or the initiation additives may be blended with one another prior to blending with the high melt flow rate polymer. Alternatively, the initiation additives may be formed into a masterbatch (e.g., the initiation additives may be blended with a carrier polyolefin (either the same or different from the high MF-R polymer) prior to contact with the high melt flow polymer), for example.

The one or more initiation additives are blended with the high melt flow rate polymers prior to extruder initiation, but blending of the initiation additives with the high MFR polymer may be discontinued upon extruder start-up. It has been observed that so long as the extruder is not shut down while running the high MFR polymer (e.g. extruder is in continuous operation), the initiation additives are not necessary to maintain extruder operation. “Start-up”, as used herein, is generally accomplished at the onset of polymer solidification and is determined by visual inspection.

Accordingly, one or more embodiments of the invention include discontinuing the contact of the initiation additives with the high melt flow rate polymer after extruder start-up. After discontinuing contact, the extruder may be purged with the high melt flow rate polymer absent initiation additives for a period prior to producing commercial polymer, for example. The purging period is generally dependent upon individual processes, including individual extruder volumes. However, it is preferable that the purging occurs continuously (e.g., extruder operation is uninterrupted).

It is contemplated that the high melt flow rate polymers may further be contacted with additional additives, which may or may not include those utilized as initiation additives, prior to extrusion. These additional additives are generally utilized to enhance polymer properties and may remain in the commercial polymer product.

While the embodiments described herein are described with reference to high MFR polymers, it is contemplated that embodiments of the invention (e.g., addition of initiation additives to a polymer prior to extrusion) may be utilized with polymers other than high MFR polymers in order to ease extrusion initiation. For example, the initiation additives may be added to low melting random copolymers, syndiotactic polypropylene or combinations thereof.

### Polymer Product

The polymers (and blends thereof) formed via the processes described herein may include, but are not limited to, linear low density polyethylene, elastomers, plastomers, high density polyethylenes, low density polyethylenes, medium density polyethylenes, polypropylene homopolymers, polypropylene impact copolymers, polyalphaolefins, polypropylene random copolymers and polypropylene copolymers, for example.

Unless otherwise designated herein, all testing methods are the current methods at the time of filing.

In one or more embodiments, the polymers generally have a high melt flow rate and may be referred to herein as high MFR polymers. As used herein, the term “high melt flow rate” refers to a polymer having a melt flow rate measured by ASTM D-1238 of at least about 5 g/10 min., or at least about 10 g/10 min., or at least about 20 g/10 min., or at least about 23 g/10 min. or at least about 25 g/10 min., for example. In one or more embodiments, the polymers are formed from Ziegler-Natta catalysts. The Ziegler-Natta formed polymers may have a melt flow rate of at least about 20 g/10 min., or at least about 23 g/10 min. or at least about 25 g/10 min., for example. In one or more embodiments, the polymers are formed from single site transition metal catalysts (e.g., metallocene catalysts). The metallocene catalyst may have a melt flow rate of at least about 20 g/10 min., or at least about 23 g/10 min. or at least about 25 g/10 min., for example.

In one or more embodiments, the polymer includes propylene based polymers. The propylene based polymers may include propylene homopolymers, propylene based random copolymers or propylene based impact copolymers, for example.

In one or more embodiments, the high MFR polymers are formed from a metallocene catalyst or other single site catalyst. In one or more embodiments, the high MFR polymers are formed from a single site catalyst capable of forming a polymer having a narrow molecular weight distribution (M_{w}/Mₙ). As used herein, the term “narrow molecular weight distribution” refers to a polymer having a molecular weight distribution of from about 1.5 to about 8, or from about 2.0 to about 7.5 or from about 2.0 to about 7.0, for example.

In one or more embodiments, the polymers are isotactic. “Tacticity” refers to the spatial arrangement of pendant groups in a polymer. For example, a polymer is “atactic” when its pendant groups are arranged in a random fashion on both sides of a hypothetical plant through the main chain of the polymer. In contrast, a polymer is “isotactic” when all its pendant groups are arranged on the same side of the chain and “syndiotactic” when its pendant groups alternate on opposite sides of the chain. The tacticity of a polymer may be analyzed via NMR spectroscopy, wherein “mmmm” (meso pentad) designates isotactic units and “rrrr” (racemic pentad) designates syndiotactic units. One or more embodiments include high crystallinity propylene based polymers (e.g., polypropylene having a meso pentad greater than about 95%).

In one or more embodiments, the polymer includes ethylene based polymers.

### Product Application

The polymers and blends thereof are useful in applications known to one skilled in the art, such as forming operations (e.g., film, sheet, pipe and fiber extrusion and co-extrusion as well as blow molding, injection molding and rotary molding). Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, monofilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, sheet, thermoformed sheet, geomembranes and pond liners, for example. Molded articles include single and multi-layered constructions in the form of bottles, tanks, large hollow articles, rigid food containers and toys, for example.

### EXAMPLES

### Example 1

Various polymer samples were extruded to observe the ease of extruder start-up with each polymer, along with pellet defects as a result of extrusion. Each polymer sample was extruded to form a 2 mil film, which was then evaluated for gel content. During extrusion, a flat knife blade was used to test the melt consistency of the polymer for subsequent evaluation of stiffness and stickiness. The observations follow in Table 1 below.

Polymer A (control sample) includes a metallocene produced 23 MFR polypropylene homopolymer including 300 ppm of Inganox® 3114, 700 ppm of Irgafos® 168, both commercially available from from Ciba Specialty Chemicals, and 400 ppm of calcium stearate.

Polymer B includes Polymer A modified with 1 wt. % of a polyethylene.

Polymer C includes Polymer A modified with 1 wt. % talc.

Polymer D includes Polymer A modified with 0.2 wt. % EBS.

Polymer E includes Polymer A modified with 5 wt. % of a polypropylene (3228, commercially available from TOTAL PETROCHEMICALS, USA, Inc.).

Polymer F includes Polymer A modified with 5 wt. % of the polyethylene formed by a chromium catalyst (HP 401 N, commercially available from TOTAL PETROCHEMICALS, USA, Inc.).

Polymer G includes Polymer A modified with 1 wt. % of the polyethylene, 1 wt. % talc and 0.2 wt. % EBS.

Polymer H includes Polymer A modified with 3.8 wt. % of the polyethylene, 1 wt. % talc and 0.2 wt. % EBS.

Polymer I includes Polymer A modified with 1 wt. % talc and 0.2 wt. % EBS.

TABLE 1

| Polymer | Onset of | |
|---|---|---|
| Sample | Solidification (C) | Egan Rating |
| A | 119.0 | Very light |
| B | 118.2 | Very light |
| C | 127.0 | Heavy |
| D | 120.1 | Very light |
| E | 120.3 | Moderate |
| F | 118.0 | Very heavy |
| G | 121.8 | Very heavy |
| H | NR | Very heavy |
| I | NR | Very heavy |

As used herein, the onset of solidification was measured using dynamic mechanical analysis on compression molded samples while cooling the samples from the melt. The solidification point was marked as the intersection of a slope change in the storage modulus response of DMA. The Egan Rating was used to measure the amount of gels (particles greater that 700 μm) observed in the polymer samples upon cutting and is measured using an optical scanning device that has been correlated to the a visual gel rating.
NR means not recorded.

It was observed that the use of first initiation additive, in conjunction with a migratory slip agent considerably improved pellet cuttability. In contrast, it was observed that polyethylene modification resulted in stiffness reduction, along with an increase in stickiness. It was further observed that polyethylene addition significantly increased the amount of gels. Gels may be detrimental in subsequent processing to produce polymer articles and therefore gels are typically minimized. Further, gel production generally increases the amount of purging time required.

### Example 2

Based on the observations experienced in Example 1, Polymer A and Polymer I were further evaluated under varying extruder conditions.

Both polymer samples were passed through a twin screw extruder equipped with an underwater pelletizer. Nine runs were completed with varying start-up conditions. The various start-up conditions included purge time prior to extruder start-up, cleanliness of the extruder die and polymer residence time prior to start-up. The run conditions and results observed are listed below.

Run 1 Conditions: Polymer A, purge time=15 mins., thoroughly cleaned die, residence time=0 mins. Observations: Smooth start up; run time=30 mins, no pelletization issues.

Run 2 Conditions: Polymer A, purge time=1-2 mins., quickly cleaned die, residence time=0 mins. Observations: start up accomplished; run time=30 mins, smaller pellets with some tails.

Run 3 Conditions: Polymer A, purge time=15 secs., residence time=15-20 mins. Observations: immediate shut down due to polymer wrapping around cutter.

Run 4 Conditions: Polymer A, purge time=15 secs., die thoroughly cleaned from Run 3, residence time=15-20 mins. Observations: immediate shut down due to polymer wrapping around cutter.

Run 5 Conditions: Polymer A, purge time=15 mins., thoroughly cleaned die, residence time=0 mins. Observations: Smooth start up; run time=30 mins, no pelletization issues.

Run 6 Conditions: Polymer I, purge time=15 mins., thoroughly cleaned die, residence time=0 mins. Observations: Smooth start up; run time=30 mins, pellets contained tsome tails and chunks at beginning but acceptable pellets produced after about 10 minutes.

Run 7 Conditions: Polymer I, purge time=15 mins., thoroughly cleaned die, residence time=0 mins. Observations: Smooth start up; run time=30 mins, pellets contained some tails and chunks at beginning but acceptable pellets produced after about 5-10 minutes.

Run 8 Conditions: Polymer I, purge time=0 secs., cleaned die, residence time=15-20 mins. Observations: smooth start up, tails widespread without improvement.

Run 9 Conditions: Polymer I, purge time=0 secs., cleaned die, residence time=15-20 mins. Observations: smooth start up, run time=15 mins. tails widespread without improvement.

Overall, it was observed that Polymer I was easier to start-up in the extruder. However, Polymer I was more prone to pellet defects.

While the foregoing is directed to embodiments of the present invention, other and further embodiments of the invention may be devised without departing from the basic scope thereof and the scope thereof is determined by the claims that follow.

What is claimed is:

1. A polymerization process comprising:
contacting an olefin monomer with a catalyst system to form polymer within a reaction vessel;
withdrawing polymer from the reaction vessel;
contacting the polymer with one or more initiation additives to form a modified polymer; and
extruding the modified polymer.

2. The polymerization process of claim 1, wherein the olefin monomer is selected from propylene, ethylene and combinations thereof.

3. The polymerization process of claim 1, wherein the olefin monomer consists essentially of propylene.

4. The polymerization process of claim 1, wherein the catalyst system comprises a single site transition metal catalyst.

5. The polymerization process of claim 1, wherein the catalyst system comprises a Ziegler-Natta catalyst.

6. The polymerization process of claim 5, wherein the polymer exhibits a melt flow rate of at least 20 g/10 min.

7. The polymerization process of claim 1, wherein the polymer is isotactic.

8. The polymerization process of claim 7, wherein the polymer exhibits high crystallinity.

9. The polymerization process of claim 1, wherein the one or more initiation additives comprise a first initiation additive and a second initiation additive.

10. The polymerization process of claim 9, wherein the first initiation additive is selected from talc, silica, zinc oxide, sodium benzoate carboxylic acid salts, phosphates, metallic-silicate hydrates, organic derivatives of dibenzylidene sorbitol, sorbitol acetals, organophosphate salts and combinations thereof.

11. The polymerization process of claim 9, wherein the first initiation additive comprises talc.

12. The polymerization process of claim 9, wherein the second initiation additive is selected from stearates, stearamides, oleamides and combinations thereof.

13. The polymerization process of claim 9, wherein the second initiation additive comprises ethylene bis-stearamide (EBS).

14. The polymerization process of claim 1, wherein the modified polymer comprises from about 0.05 wt. % to about 5 wt. % initiation additive.

15. The polymerization process of claim 1 further comprising:
terminating the contact of the unmodified polypropylene with the one or more initiation additives to form modified polymer without interrupting extrusion to form polymer pellets.

16. A polymerization process comprising:
contacting propylene monomer with a metallocene catalyst system to form unmodified polypropylene within a reaction vessel, wherein the polypropylene comprises a melt flow rate of at least 20 g/10 min.;
withdrawing the unmodified polypropylene from the reaction vessel.
contacting the unmodified polypropylene with a first initiation additive comprising talc and a second initiation additive comprising a migratory slip agent to form a modified polymer;
extruding the modified polymer;
terminating the contact of the unmodified polypropylene with the one or more initiation additives to form modified polymer without interrupting extrusion to form polymer pellets.

17. A polymer formed from the process of claim 16.

18. The polymer of claim 17 comprising polypropylene.
